(19) United States
(12) Patent Application Publication
(10) Pub. No.: US 2026/0200428 A1
(43) Pub. Date: Jul. 16, 2026

(54) MUSHROOM AIRBAG WITH ADAPTIVE CHAMBER

(71) Applicant: CIS Tech LLC., Shelby Township, MI (US)

(72) Inventor: Jong Seop Nam, Santa Ana, CA (US)

(21) Appl. No.: 19/430,829

(22) Filed: Dec. 23, 2025

Related U.S. Application Data
(60) Provisional application No. 63/746,086, filed on Jan. 16, 2025.
(60) Provisional application No. 63/745,070, filed on Jan. 14, 2025.

(51) Int. Cl. B60R 21/233; B60R 21/205; B60R 21/2338; B60R 21/237; B60R 21/264; B60R 21/00; B60R 21/235

(52) U.S. Cl. CPC B60R 21/233; B60R 21/205; B60R 21/2338; B60R 21/237; B60R 21/264; B60R 2021/0009; B60R 2021/0032; B60R 2021/0048; B60R 2021/23308; B60R 2021/23382; B60R 2021/23509

(57) ABSTRACT

A passenger airbag cushion having a mushroom shape with a substantially deeper upper airbag chamber than a lower airbag chamber. The upper airbag chamber is divided into a front chamber facing towards an occupant and a rear chamber facing towards and instrument panel. A substantially vertical membrane extends across a width of the airbag cushion to separate the rear chamber, which is combined with the lower airbag chamber to form a single main airbag chamber resembling the traditional airbag cushion, and the front chamber becoming an adaptive chamber which receives gas from the main airbag chamber. The adaptive airbag chamber is softer than the main chamber and adapts in depth and shape passively in response to different occupant positions and vehicle crash modes in order to effectively restrain the occupant head and brain with a soft and uniform landing.

### CROSS REFERENCE TO RELATED APPLICATIONS

The present application claims the priority of USSN 63/745,070 filed January 14, 2025 and USSN 63/746,086 filed January 16, 2025.

### FIELD OF THE INVENTION

This invention relates to a passenger airbag system for use with a motor vehicle, wherein the airbag cushion has a mushroom shape with an adaptive chamber in such a way to effectively protect various occupants from diverse crash conditions.

### BACKGROUND OF THE INVENTION

A vehicle crash involves different vehicle motions with various occupant sizes and seating positions. The occupant may move straight forward or at an angle toward the center of the vehicle or A-pillar. A typical traditional airbag without adaptive design features can provide a limited protection for the varying occupant motions and positions.

### SUMMARY OF THE INVENTION

The present invention discloses a mushroom airbag system incorporating an adaptive chamber which is designed to further reduce the occupant head and brain injury risk from various vehicle crash modes and seating positions.

An upper airbag chamber of the mushroom airbag is divided into a front chamber and a rear chamber by a membrane such as a fabric panel or wide tether, while maintaining the mushroom shape. The front chamber faces the occupant, while the rear chamber faces the windshield and instrument panel. The membrane has an opening such as a vent hole, enabling gas flow from the inflator to the rear chamber first and then to the front chamber.

The design allows the front chamber to function as an adaptive chamber, dynamically adjusting its inflation based on the occupant's position and direction of motion. For occupants seated closer to the instrument panel, the adaptive chamber inflates minimally due to limited time and space, resembling a traditional airbag. For occupants seated farther away, the adaptive chamber inflates more fully, providing deeper engagement and enhanced restraint than the traditional airbag.

As the adaptive chamber inflates after the main chamber, it becomes softer than the main chamber during the initial contact with the occupant’s head, which can reduce the risk of brain rotational injuries that can occur with stiffer traditional airbags, especially from angled or offset crash events creating an oblique head impact into the airbag cushion. In later stages of the crash event, the adaptive chamber forms a stiffer lobe on each side of the occupant's head, limiting lateral head movement and reducing the risk of impact with interior parts of the vehicle such as the center display screen or A-pillar.

In summary, the adaptive chamber is designed to adjust itself to various occupant positions and vehicle motions, aiming to provide effective head and brain protection.

### BRIEF DESCRIPTION OF THE DRAWINGS

Reference will now be had to the attached drawings, when read in combination with the following detailed description, wherein like reference numerals refer to like parts throughout the several views, and in which:

FIG. 1 shows a traditional passenger airbag system commonly used in today’s vehicles according to the Prior Art;

FIG. 2 shows an embodiment of a Prior Art airbag design featuring a larger upper airbag chamber and a smaller lower airbag chamber with a significant recess, creating a mushroom shape;

FIGS. 3A and 3B depict each of side and top views of a non-limiting embodiment of a mushroom airbag with adaptive chamber according to the present invention in which the upper airbag chamber is divided into a front chamber and a rear chamber, making the front chamber an adaptive chamber;

FIGS. 4A and 4B depict each of side and top views substantially as shown in FIGS. 3A-3B and depicting the adaptive chamber deployed with a minimal inflation for an occupant seated closer to the vehicle instrument panel;

FIGS. 5A and 5B further depict each of top and side views again as substantially shown in FIGS. 3A-3B in which the adaptive chamber deploys with a fuller inflation for an occupant seated further away from the vehicle instrument panel;

FIGS. 6A and 6B depict each of top and side views of an embodiment of the present invention as described in FIGS. 3A-3B in which the adaptive chamber forms stiffer dual lobes beside the passenger head in latter stage of a crash event;

FIGS. 7A-7B depict each of left and right oblique impact views of the present invention as described in FIGS. 3A-3B in which the adaptive chamber forms asymmetric dual lobes beside the passenger head from oblique impacts; and

FIG. 8 depicts an embodiment of the mushroom airbag with adaptive chamber similar to as shown in FIG. 3A in which the airbag cushion has a negative offset in design configuration between the main chamber and the vehicle instrument panel.

### DETAILED DESCRIPTION OF THE DRAWINGS

With reference to the attached illustrations, the present invention discloses a mushroom airbag system incorporating an adaptive chamber which is designed to further reduce the occupant head and brain injury risk from various vehicle crash modes and seating positions. For purposes of definition, the front of an airbag cushion is directed toward a passenger, with the rear directed away from the passenger or toward the instrument panel. Therefore, the front of an airbag cushion faces the rear of the vehicle.

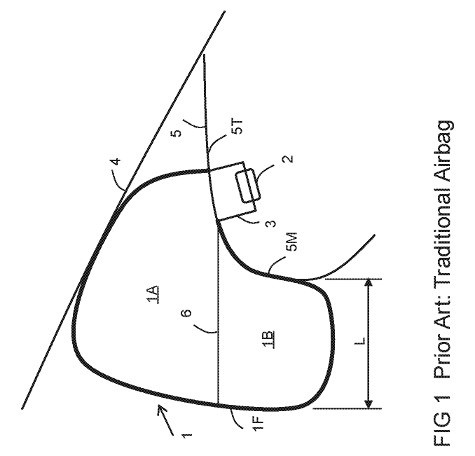

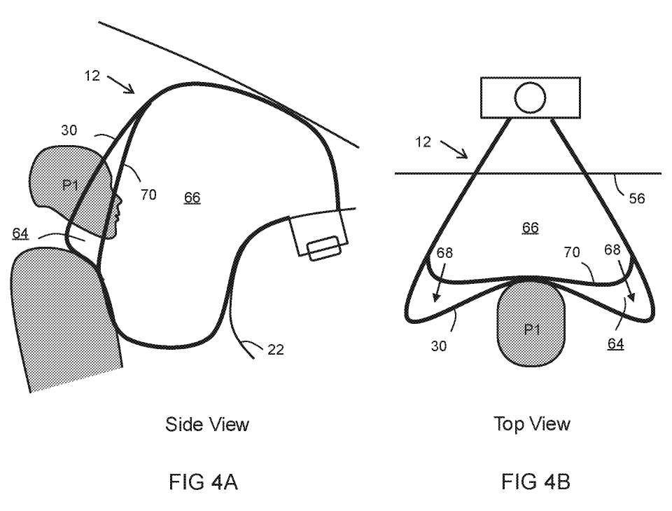

FIG. 1 shows a typical traditional passenger airbag system according to the Prior Art of an airbag cushion which is generally shown at 1, an airbag housing 3, and a gas generating inflator 2. A vehicle instrument panel is represented at 5 and has a top portion 5T with a surface generally facing a windshield 4 and a mid-portion 5M with a surface generally facing an occupant (not shown in this view but subsequently shown in FIGS. 4 et seq.).

The airbag cushion 1 typically has a tether 6. For definitional purposes, the airbag may be said to have an upper airbag chamber 1A above the tether and a lower airbag chamber 1B below the tether. The length L of the airbag cushion can be defined as the length between the airbag cushion front 1F and the mid portion of the instrument panel 5M.

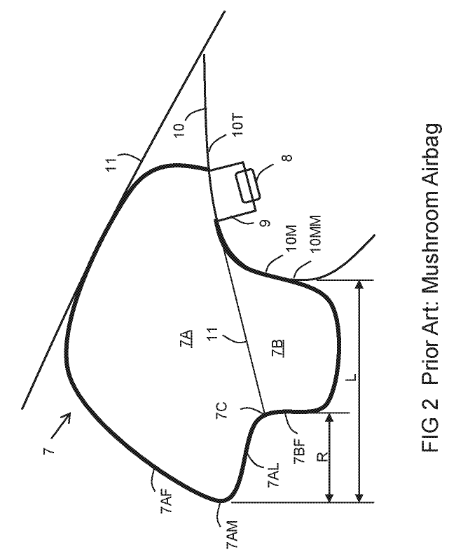

FIG. 2 shows an embodiment of a conventional version of a mushroom airbag which includes an airbag housing 9 mounted in a top portion 10T of an instrument panel 10, also having an intermediate mid-portion location 10M with a surface generally facing an occupant, and with a gas generating inflator 8. An airbag cushion, as generally shown at 7, includes a main upper chamber 7A and a supporting lower chamber 7B. The upper chamber 7A is significantly deeper towards the occupant and larger in volume than the lower chamber 7B. A lower face 7AL of the upper chamber 7A is connected to a front face 7BF of the lower chamber 7B at a connection region 7C.

As shown, the front face 7BF of the lower chamber 7B is substantially recessed or offset from the front face 7AF of the upper chamber, by an amount R. The recess or offset R may be referred to as the lower airbag chamber front offset and is defined as the horizontal distance between a point 7AM of the front face 7AF of the upper airbag chamber 7A being the farthest point from the instrument panel and the connection region 7C. The upper airbag chamber 7A has an upper airbag chamber depth or length L, equal to a horizontal distance between the point 7AM and a further location 10MM of the mid portion of the instrument panel 10 being the closest point to the passenger (again not shown in this view). The lower airbag chamber front offset R is typically at least one quarter (or 25%) of the length L, with the deeper and larger upper airbag chamber 7A intended to maximize the head protection while making the airbag deployment in-position time quicker by having a shallower and smaller lower airbag cushion.

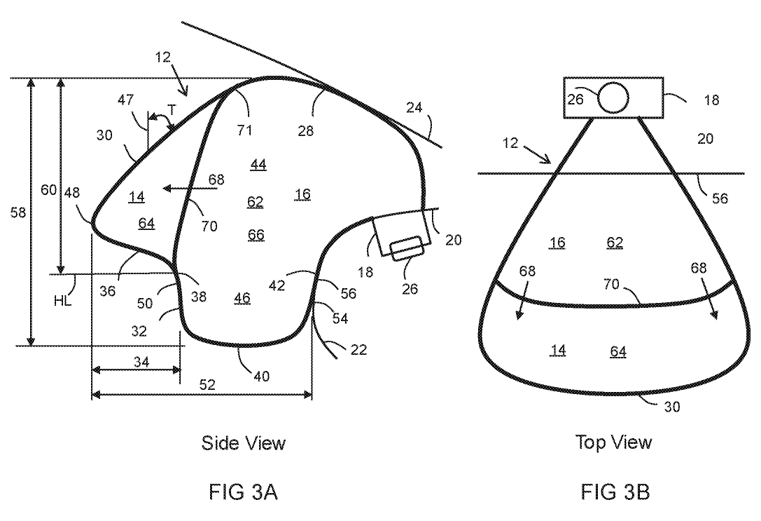

Proceeding to FIGS. 3A and 3B, depicted are each of side and top views respectively of a non-limiting embodiment of a mushroom airbag cushion, which is defined by a body shown generally at 12 that may be said for definitional purposes to have a larger and deeper upper airbag chamber 44 and a smaller and shallower lower airbag chamber 46 creating a mushroom shape in a sideview in which the upper airbag chamber 44 is divided into a front upper chamber 14 and a rear upper chamber 16, making the front upper chamber 14 an adaptive chamber. Without limitation, the figures presented may represent the airbag cushion in any of a design configuration or fully deployed and inflated configuration, with the passenger (see again FIG. 4) assumed to be behind the airbag cushion towards vehicle rearward.

The passenger airbag system includes an airbag housing 18 mounted in a top portion 20 of an instrument panel 22 disposed between a windshield 24 and a passenger with a gas generating inflator 26. The airbag housing contains the airbag cushion in a folded configuration which is deployable through the top portion 20 of the instrument panel.

The airbag cushion 12 has a top portion 28 adjacent to the windshield 24, an upper front portion 30 facing the passenger, a lower front portion 32 facing the passenger with a recess 34 from the upper front portion 30, an upper bottom portion 36 facing generally downward created by the recess 34, a connection region 38 where the upper bottom portion 36 meets the lower front portion 32, a lower bottom portion 40 facing downward, and a rear portion 42 adjacent to a mid-portion 56 of the instrument panel 22.

For definitional purposes, the rear upper chamber 16 may be said to have an upper airbag sub-chamber 62 above a horizontal line HL drawn through the connection region 38 and a lower airbag sub-chamber 46 below the horizontal line HL. The front face of the upper airbag chamber 30 may be slanted forward in vehicle with an angle T taken from a vertical axis 47 and when measured with an average amount, the slanted angle T defined as extending through a midpoint of the adaptive chamber when measured throughout the front face.

The upper airbag chamber 44 is the main airbag chamber which, as shown, is substantially larger in volume and deeper towards the passenger than the lower airbag sub-chamber 46, creating a mushroom-shape airbag cushion in a side view.

The front recess or offset 34 may be referred to as the lower airbag chamber front offset and is defined as the horizontal distance between a portion 48 (also defined as a forward most expanded point of the airbag cushion 12) of the front face 30 of the upper airbag chamber 44, thereby being a farthest point from the instrument panel and the connection region 38. The front offset 34 can also be defined as the horizontal distance between the portion 48 of the front face 30 of the upper airbag chamber 44 being the farthest point from the instrument panel and a portion 50 of the front face 32 of the lower airbag chamber 46 being the closest point to the passenger.

The upper airbag chamber 44 may be said to have an upper airbag chamber length 52 equal to the horizontal distance between the point 48 and a point 54 being a portion of the instrument panel front face 56 being the closest point to the passenger. The recess or offset 34 may be measured from the design configuration or the fully deployed and inflated configuration with the passenger behind the airbag cushion.

The airbag cushion 12 also has an airbag cushion height 58 equal to the vertical distance between the highest point of the upper airbag chamber 44 and the lowest point of the lower airbag chamber 46. The upper airbag chamber 44 has an upper airbag chamber height 60 equal to the vertical distance between the highest point of the upper airbag chamber 44 and the connection region 38. The upper airbag chamber height 60 can without limitation be at least 40% of the total airbag cushion height 58 in order to protect the passenger head effectively.

The upper airbag chamber 44 is physically divided into the upper airbag sub-chamber 62 and a front airbag chamber 64 by a substantially vertical membrane or panel 70, fully extending from one side of the airbag cushion to the other side as shown by the top view. The upper airbag sub-chamber 62 is located towards the instrument panel 22 and windshield 24. The front airbag chamber 64 is located towards the passenger.

As further shown, the upper airbag sub-chamber 62 and the lower airbag chamber 46 forms a single airbag chamber 66. For definitional purposes, the front chamber 64 is named an adaptive airbag chamber, and the single airbag chamber 66 is named a main airbag chamber. The adaptive chamber 64 is a supporting chamber being adaptive. The front face 30 of the adaptive chamber is preferred to have a slant angle T being in a range of at least ten degrees to twenty degrees or higher.

The gas generated by the inflator 26 flows into the main airbag chamber 66 first and then into the adaptive chamber 64 through an opening (see arrow at 68) in a membrane 70 separating the chambers 64 and 66. In one non-limiting embodiment, the vertical membrane extends a width of the airbag cushion in a cross-car direction.

As further best shown in the side view of FIG. 3A, the configuration of the adaptive chamber 64 is such that it defines a generally teardrop shape extending forwardly from the main airbag chamber 66, and by which the upper front portion 30 of the adaptive chamber 64 extends at a downward and forward angled slant (again defined by slant angle T) from an upper connection location 71 with the membrane 70. The forward extending portion 30 of the adaptive chamber extends to the forward most point 48 coinciding with a general midpoint of the overall height 58 of the airbag cushion in a fully inflated configuration, following which the upper body portion 36 reverse angles in an inward reverse curve before rejoining the main airbag at the connection region 38, this coinciding with the bottom end of the separating membrane 70 which is located on the front face of the main chamber 66 above its bottom portion 40 as defined by the lower front portion 32.

In operation, the gas inflates the main chamber 66 first, followed by the adaptive chamber 64, making the adaptive chamber softer than the main chamber with lower pressure throughout the occupant loading. The amount of inflation of the adaptive chamber 64 depends on the space between the instrument panel and the passenger at the time of initial interaction.

The embodiment of the present invention shown by FIGS. 3A and 3B can be constructed either by constructing the mushroom shaped airbag cushion first then adding the membrane inside the cushion or by constructing the traditional airbag cushion first then adding the adaptive chamber outside the cushion. The airbag cushion with the adaptive chamber added becomes substantially deeper than the traditional airbags to maximize the head protection yet still can get positioned in time for a passenger sitting close to the instrument panel. A tether may not be required to be added because the airbag cushion has a multi-chamber construction enabling a stable airbag shape formation after inflation. Without limitation, the lower airbag chamber front offset 34 can be any percentage of the upper airbag chamber length 52, not limited to at least 10% in order to optimize the effectiveness of the adaptive chamber 64 in restraining the head of the passenger.

Proceeding to FIGS. 4A-4B, depicted each of side and top views substantially as shown in FIGS. 3A-3B and depicting the adaptive chamber 64 deployed with a minimal inflation for an occupant seated closer to the vehicle instrument panel 22, this refenced by passenger P1 sitting close to instrument panel 22 creating a small space or gap between the passenger and the instrument panel. The adaptive chamber 64 as shown meets the passenger with a partially inflated chamber due to the small space and lack of time for airbag inflation while the passenger is quickly closing the gap, via his or her forward inertial movement, during a collision event. As a result, the airbag cushion 12 defines a shallower and slightly deeper and larger configuration as compared to the traditional airbag cushion 1 depicted in the Prior Art view of FIG. 1.

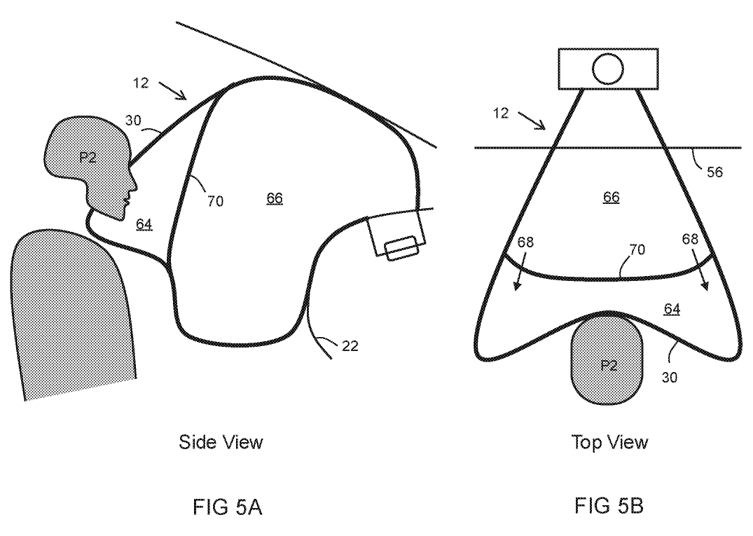

FIGS. 5A and 5B further depict each of top and side views again as substantially shown in FIGS. 3A-3B in which the adaptive chamber 64 deploys with a fuller inflation for an occupant seated further away from the vehicle instrument panel 22, creating a larger space or gap between the passenger and the instrument panel. The adaptive chamber 64 meets the passenger with a more fully inflated configuration due to the larger space and more time for airbag inflation. The passenger head, see at P2, in this instance makes a soft landing into the adaptive airbag chamber being softer than the main airbag chamber 66.

In this application, the head interaction is more uniform than the other airbag cushions having distinct dual lobes, and owing to the adaptive chamber 64 defining a single lobe. As such, the passenger head P2 can impact on any part of the adaptive chamber 64 from various crash modes providing a uniform interaction. This soft and uniform landing can help reduce the risk of brain rotational injuries caused by a hard landing on the stiff traditional airbag cushion or other airbags with non-uniform front surface, especially from an angled or oblique impact as well as straight forward impact.

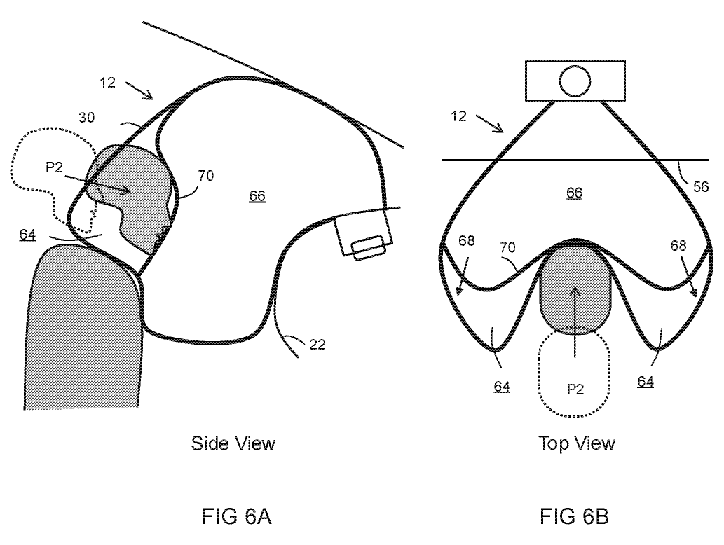

FIGS. 6A and 6B depict each of top and side views of an embodiment of the present invention as described in FIGS. 3A-3B in which the adaptive chamber 64 forms stiffer dual lobes beside the passenger head P2 in a latter stage of a crash event in which the passenger head is pressing the main airbag chamber 66 as well as the adaptive airbag chamber 64 (i.e. including the lobes exerting increased pressure in the latter stages of a crash event). The adaptive chamber 64 as best shown in the top view of FIG. 6B forms two lobes, one on each side of the passenger head P2. The lobes are stiffer at this stage as the passenger head is pushing the main airbag chamber and forcing more gas to flow into the adaptive airbag chamber through the opening in the membrane 70, and by which the arrangement of the two lobes can protect the passenger head P2 effectively by stabilizing the head motion.

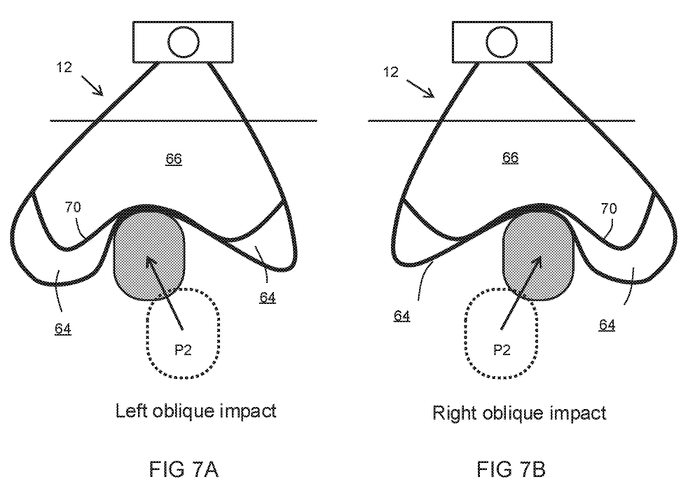

FIGS. 7A-7B depict each of left and right oblique impact views of the present invention as described in FIGS. 3A-3B in which the adaptive chamber 64 forms asymmetric dual lobes beside the passenger head P2 from either of first and second examples of oblique impact events, such typically occurring at later stages of the crash event when the passenger head moves at an angle toward center of the vehicle from left oblique impacts or toward A-pillar from right oblique impacts. The adaptive chamber 64 forms asymmetric dual lobes, one on left and the other on right of the passenger head. The inboard lobe from the left oblique impact or the outboard lobe from the right oblique impact is expected to be more bulged out than the other side lobe and thus effectively restrain the head from sliding or rolling off the airbag cushion, potentially hitting a center display screen or A-pillar.

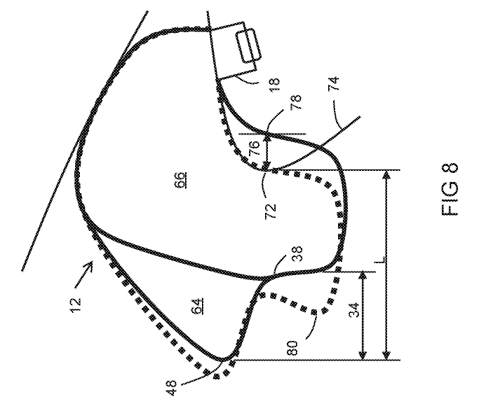

Finally, FIG. 8 depicts an embodiment of the mushroom airbag with adaptive chamber similar to as shown in FIG. 3A in which the airbag cushion 12 has a negative offset in design configuration between the main chamber 66 and the vehicle instrument panel 22. This is expressed by solid lines and its deployed configuration expressed by dotted lines. The front face 72 of the instrument panel (see at 74) is deeper than the airbag cushion 12 toward the passenger measured from the airbag housing 18. This creates a negative offset 76 in design configuration between the mid portion 72 of the instrument panel 74 being the closest point to the passenger and a rear portion 78 of the airbag cushion 12 when drawn and measured horizontally from the point 72. During the airbag inflation, the instrument panel pushes out the rear portion of the airbag cushion and makes a bulged-out portion as shown at 80. The lower chamber front offset, previously identified at 34, is measured from the design configuration in which the upper airbag chamber length L is measured from the point 48 to the point 72.

As will be clear to those of skill in the art, the herein disclosed and described embodiment of the present invention may be altered in various ways without departing from the scope or teaching of the present invention. It is the following claims, including all equivalents, which define the present invention.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, the drawings/figures should be considered only as exemplary, and not limiting, unless otherwise specifically specified.

1. A passenger airbag system for an automotive vehicle having a passenger compartment, a windshield, and an instrument panel disposed between the passenger compartment and the windshield, the instrument panel having a top portion adjacent the windshield with a surface generally facing the windshield and a mid-portion further away from the windshield with a surface generally facing a passenger, the passenger airbag system comprising:
an airbag housing adapted to being mounted in the top portion of the instrument panel, said airbag housing having a folded airbag cushion disposed therein when said airbag cushion is in a non-deployed configuration, in response to a crash event said airbag cushion being deployable from said airbag housing through the instrument panel;
said airbag cushion having an upper airbag chamber, a lower airbag chamber, said upper airbag chamber being a main airbag chamber and having a larger volume than said lower airbag chamber, said lower airbag chamber being a supporting airbag chamber;
a gas generating inflator operable to generate a flow of gas into both of said upper and lower chambers;
said upper airbag chamber having a front face adapted to facing the passenger and a lower face directed generally downwardly;said lower airbag chamber having a front face adapted to facing the passenger, a lower face directed downwardly, and a rear face directed toward the mid portion of the instrument panel, said front face of said lower airbag chamber having an upper edge joined to said lower face of said upper airbag chamber at a connection region such that said front face of said lower airbag chamber extends downwardly from said lower face of said upper airbag chamber;
an upper airbag chamber length being defined as a horizontal distance between said front face of said upper airbag chamber at a farthest point from the instrument panel and a midportion of the instrument panel closest to the passenger;
a lower airbag chamber front offset being defined as a horizontal distance between said front face of said upper airbag chamber at a farthest point from the instrument panel and a connection region where said front face of the lower airbag chamber joins said lower face of said upper airbag chamber, said lower airbag chamber front offset being at least 10% of said upper airbag chamber length;
said upper airbag chamber being physically divided into a front airbag chamber and a rear airbag chamber by a membrane such as a fabric panel or wide tether extending a width of said airbag cushion in a cross-car direction, said rear airbag chamber being combined with said lower airbag chamber to create a main airbag chamber adapted to receiving gas directly from said inflator;said membrane having an opening through which the gas flows from said main airbag chamber into said front airbag chamber, said front airbag chamber further being defined as an adaptive airbag chamber;in a first configuration, said adaptive airbag chamber inflating minimally for a passenger sitting closer to the instrument panel, forming a shallow airbag chamber;in a second configuration, said adaptive airbag chamber inflating more fully for a passenger sitting further away from the instrument panel, forming a deeper airbag chamber; andsaid adaptive airbag chamber being softer with lower pressure than the main airbag chamber during initial interaction with the passenger head providing a soft and uniform landing;
and said adaptive airbag chamber forming a pair of lobes beside a head of the passenger, with an increase in restraining pressure in later stages of the crash event.

2. The passenger airbag system in accordance with claim 1, further comprising said airbag cushion being constructed by adding said membrane to form said adaptive chamber, making
the airbag cushion substantially deeper to maximize the head protection, while positioned in time to inflate for cushioning a passenger sitting close to the instrument panel due to the shallower lower airbag chamber with the offset.

3. The passenger airbag system in accordance with claim 1, further comprising said adaptive chamber fabricated so as to be attached to said main airbag chamber, making the airbag cushion substantially deeper than the traditional airbag cushion to maximize head protection of the passenger.

4. The passenger airbag system in accordance with claim 1, further comprising said lower airbag chamber front offset measured from a design configuration of said airbag cushion with the passenger located behind said airbag cushion.

5. The passenger airbag system in accordance with claim 1, further comprising said lower airbag chamber front offset measured from a fully deployed and inflated configuration of said airbag cushion with the passenger located behind said airbag cushion.

6. The passenger airbag system in accordance with claim 1, further comprising said lower airbag chamber front offset being at least 20% of a length of said upper airbag chamber.

7. The passenger airbag system in accordance with claim 1, further comprising said lower airbag chamber front offset defined as a horizontal distance between a portion of said front face of said upper airbag chamber being a farthest point from the instrument panel and a portion
of said front face of said lower airbag chamber being a farthest point from the instrument panel, wherein said lower airbag chamber front offset is at least 10% of said upper airbag chamber length.

8. The passenger airbag system in accordance with claim 1, further comprising an airbag cushion height defined as a length between a highest portion of said upper airbag chamber and a lowest portion of said lower airbag chamber, and an upper airbag chamber height defined as a length between a highest portion of said upper airbag chamber and said connection region, wherein, said upper airbag chamber height is at least 40% of said airbag cushion height.

9. The passenger airbag system in accordance with claim 1, further comprising said front face of said adaptive airbag chamber being slanted at least twenty degrees forward from a vertical axis extending through a midpoint of the adaptive chamber when measured throughout the front face.

10. The passenger airbag system in accordance with claim 1, further comprising said airbag cushion having a negative rear offset in a design configuration between said rear portion of said airbag cushion and the mid portion of the instrument panel.

11. A passenger airbag system for an automotive vehicle having a passenger compartment, a windshield, and an instrument panel disposed between the passenger compartment and the windshield, the instrument panel having a top portion with a surface facing the windshield and a mid-portion facing a passenger, said airbag system comprising:
a housing adapted to being mounted in the top portion of the instrument panel, a folded airbag cushion disposed therein when said airbag cushion is in a non-deployed configuration, said airbag cushion being deployable from said airbag housing through the instrument panel;
said airbag cushion having a larger and deeper upper airbag chamber and a smaller shallower lower airbag chamber and which receives a flow of gas from a gas generating inflator incorporated into said housing;a membrane such as a fabric panel or wide tether dividing said upper airbag chamber into a front adaptive chamber and a rear chamber being combined with said lower airbag chamber forming a main airbag chamber, said membrane having an opening through which the gas flows from said main airbag chamber into said adaptive airbag chamber;said adaptive chamber defining a generally teardrop shape extending forwardly from said rear chamber, an upper front portion of said adaptive chamber extending at a downward and forward angled slant from an upper connection location with said membrane to a foremost point coinciding with a general midpoint of an overall height of the airbag cushion in a fully inflated configuration, following which said foremost point reverse angling in an inward reverse curve before rejoining said main airbag chamber at a lower connection region coinciding with the bottom end of said separating membrane located on a front face of said main airbag chamber above its bottom;in a first configuration, said adaptive chamber inflating minimally upon a crash event and contacting a passenger sitting closer to the instrument panel, forming a shallow airbag chamber;in a second configuration, said adaptive chamber inflating more fully for a passenger sitting further away from the instrument panel, forming a deeper airbag chamber; andsaid adaptive airbag chamber being softer with lower pressure than said main airbag chamber during an initial interaction with the passenger for providing a soft and uniform landing.

12. The passenger airbag system in accordance with claim 11, said general midpoint is located somewhere between one third (1/3) to two thirds (2/3) of the overall height of the airbag cushion.

13. The passenger airbag system in accordance with claim 11, further comprising said adaptive chamber forming a pair of lobes exhibiting increasing restraining pressure in later stages of the crash event loaded by the passenger head.

14. The passenger airbag system in accordance with claim 13, said pair of lobes further comprising asymmetric dual lobes located on each of left and right sides of head of the passenger and, in response to either of a left or right oblique impact, restrains sliding or rolling of the head off of the airbag cushion.

15. The passenger airbag system in accordance with claim 11, further comprising said airbag cushion exhibiting a mushroom-shape in side view.

16. The passenger airbag system in accordance with claim 11, further comprising said lower chamber having a front face adapted to facing the passenger, a lower face directed downwardly, and a rear face directed toward the mid portion of the instrument panel.

17. The passenger airbag system of claim 16, further comprising said front face of said lower airbag chamber having an upper edge joined to said lower face of said upper chamber at a
connection region such that said front face of said lower chamber extends downwardly from said lower face of said upper airbag chamber.

18. The passenger airbag system of claim 17, further comprising a length of said upper chamber being defined as a horizontal distance between said front face of said upper chamber and a midportion of the instrument panel closest to the passenger.

19. The passenger airbag system of claim 18, further comprising said lower chamber having a front offset defined as a horizontal distance between said front face of said upper airbag chamber at a farthest point from the instrument panel and a connection region where said front face of the lower airbag chamber joins said lower face of said upper airbag chamber, said lower airbag chamber front offset being at least 20% of said upper airbag chamber length.

20. The passenger airbag system of claim 11, further comprising said airbag cushion having a negative rear offset in a design configuration between said rear portion of said airbag cushion and the mid portion of the instrument panel.

21. A passenger airbag system for a vehicle having a passenger compartment, a windshield, and an instrument panel disposed between the passenger compartment and the windshield, said airbag system comprising:
a housing adapted to being mounted within the instrument panel, a folded airbag cushion contained within said housing when said cushion is in a non-deployed configuration, said airbag cushion being deployable from said airbag housing through the instrument panel;
said airbag cushion having a rear chamber and a smaller forward adaptive chamber;
a membrane such as a fabric panel or wide tether dividing said adaptive and rear chambers, said membrane having an opening through which the gas flows initially into said rear chamber and subsequently into said forward adaptive chamber;said adaptive chamber defining a generally teardrop shape extending forwardly from said rear chamber, an upper front portion of said adaptive chamber extending at a downward and forward angled slant from an upper connection location with said membrane to a forward most point coinciding with a general midpoint of an overall height of the airbag cushion in a fully inflated configuration, following which said upper front portion reverse angling in an inward reverse curve before rejoining said rear chamber at a lower connection region coinciding with the bottom end of said separating membrane located on a front face of said rear chamber above its bottom;in a first configuration, said adaptive chamber inflating minimally upon a crash event and contacting a passenger sitting closer to the instrument panel, forming a shallow airbag chamber and;in a second configuration, said adaptive chamber inflating more fully for a passenger sitting further away from the instrument panel, forming a deeper airbag chamber.
